(19) United States
(12) Patent Application Publication
(10) Pub. No.: US 2026/0045893 A1
(43) Pub. Date: Feb. 12, 2026

(54) MOTOR CONTROL DEVICE

(71) Applicant: ADVICS CO., LTD., Kariya-shi, Aichi-ken (JP)

(72) Inventor: Hikaru KAWAMURA, Kariya-shi, Aichi-ken (JP)

(21) Appl. No.: 19/101,177

(22) PCT Filed: Aug. 22, 2023
(86) PCT No.: PCT/JP2023/030215

§ 371 Date: Feb. 4, 2025

(30) Foreign Application Priority Data
Aug. 22, 2022 (JP) 2022-131453

(51) Int. Cl. H02P 6/18; H02P 8/38

(52) U.S. Cl. CPC H02P 6/181; H02P 8/38

(57) ABSTRACT

A motor control device includes a control unit that performs sensorless control of a brushless motor having three phases, and a determination unit that determines presence or absence of step-out of the brushless motor by comparing a deviation hV between a determination voltage Vqj calculated from a rotational speed w of the brushless motor and an estimated q-axis instruction voltage Vqc of the sensorless control with a determination threshold value Hs. The determination unit sets a calculation map Zhs for calculating the determination threshold value Hs to be larger than a characteristic Zes of a first error Es included in the sensorless control in a state in which the brushless motor is not out of step. For example, the determination unit sets the calculation map Zhs such that the determination threshold value Hs is determined to be larger the higher the rotational speed w.

### TECHNICAL FIELD

The present disclosure relates to a motor control device.

### BACKGROUND ART

Patent Literature 1 describes the following for the purpose of performing step-out detection with a simple configuration that eliminates the need to add a current detector or a voltage detector. A model voltage calculation unit 10 obtains the dq-axis model voltages vd* and vq* from the speed of the speed indicator of the PM motor and the dq-axis current of the current indicator using the PM motor model on the basis of the voltage equation of the PM motor 2, and a step-out determination unit 11 determines the presence or absence of step-out of the PM motor by comparing the model voltage with the voltage indicators vd and vq of the inverter. When calculating the model voltage, a dq-axis current detection value can be used instead of the current indicator of the PM motor. Furthermore, the step-out determination can be performed using only the model voltage of the q-axis component.

Patent Literature 2 describes the following so that step-out can be reliably detected even in sensorless control. The brushless motor control device rotationally drives the brushless motor 4 that applies a rotational driving force to the oil pump 5 that supplies a hydraulic pressure according to a control signal from the host device 12. The brushless motor control device 3 controls the energization to the brushless motor so that the target torque received by the control signal from the host device is obtained. When a deviation occurs between the target rotational speed and the actual rotational speed and the target rotational speed reaches the lower limit threshold value, the step-out detection means 37A determines that step-out is detected.

Incidentally, various state quantities used for step-out determination include errors. Therefore, the step-out determination is preferably executed in consideration of an error.

### CITATIONS LIST

### Patent Literature

Patent Literature 1: JP 2010-252503 A
Patent Literature 2: JP 2012-060782 A

### SUMMARY

### Technical Problems

An object of the present disclosure is to provide a motor control device that performs sensorless control of a brushless motor, in which step-out of the brushless motor can be determined in consideration of an error.

### Solutions to Problems

A motor control device (MS) according to the present disclosure includes a control unit (BC) that performs sensorless control of a brushless motor (BM) having three phases; and a determination unit (BH) that determines presence or absence of step-out of the brushless motor (BM) by comparing a deviation (hV) between a determination voltage (Vqj) calculated from a rotational speed (ω) of the brushless motor and an estimated q-axis instruction voltage (Vqc) of the sensorless control with a determination threshold value (Hs).

In the motor control device (MS) according to the present disclosure, the determination unit (BH) sets a calculation map (Zhs) for calculating the determination threshold value (Hs) to be larger than a characteristic (Zes) of a first error (Es) included in the sensorless control in a state in which the brushless motor (BM) is not out of step. For example, the determination unit (BH) sets the calculation map (Zhs) such that the determination threshold value (Hs) is determined to be larger the higher the rotational speed (ω). According to the above configuration, the determination threshold value Hs is determined so as not to be included in the range Hes of the first error Es. In the motor control device, the first error Es is taken into consideration, and the influence thereof is compensated.

In the motor control device (MS) according to the present disclosure, the determination unit (BH) calculates, as a stop voltage (Vqt), the voltage deviation (Vqj) determined in a stop state of the brushless motor (BM) on the basis of the estimated d-axis output current (Ids) and the rotational speed (ω), calculates a second error (Et) included in the stop voltage (Vqt) on the basis of the estimated d-axis and estimated q-axis output currents (Ids, Iqs), and the rotational speed (ω), and prohibits the determination when the determination threshold value (Hs) is greater than or equal to a value (Vqx) obtained by subtracting the second error (Et) from the stop voltage (Vqt). According to the above configuration, the step-out determination is prohibited when the determination threshold value Hs is included in the range Het of the second error Et. In the motor control device, the second error Et is taken into consideration, and the influence thereof is compensated.

### BRIEF DESCRIPTION OF DRAWINGS

FIG. 1 is a block diagram for explaining an embodiment of a motor control device MS.

FIG. 2 is a block diagram for explaining a determination unit BH.

FIG. 3 is a characteristic diagram for explaining setting of a determination threshold value Hs and possibility determination on step-out determination.

### DESCRIPTION OF EMBODIMENTS

### <Symbols of Configuring Members and the Like and Expression of Magnitude Relationship of Values>

In the following description, configuring members, calculation processes, signals, characteristics, and values having the same symbol such as “BM” have the same functions. In addition, the magnitude relationship for the values of various state quantities (Hs, hV, etc.) is expressed on the basis of their magnitudes (absolute values). The current, the voltage, and the like are denoted with positive and negative (+/−) signs according to the rotating direction of the motor. For example, a positive sign is denoted when the motor is driven in the forward rotation direction, and a negative sign is denoted when the motor is driven in the reverse rotation direction. That is, the sign of the state quantity is different depending on the rotating direction of the motor. Furthermore, the voltage deviation hV is calculated as a difference between a determination voltage Vqj and an estimated q-axis instruction voltage Vqc, but the signs are reversed depending on the calculation method of the voltage deviation hV. That is, the sign of the voltage deviation hV is opposite between the case of being calculated with “hV=Vqj−Vqc” and the case of being calculated with “hV=Vqc−Vqj”. Therefore, in the following description, the magnitude (or high and low) of the value is expressed with an absolute value (magnitude) of the value as a reference so as to avoid complication of the description.

### <Embodiment of Motor Control Device MS>

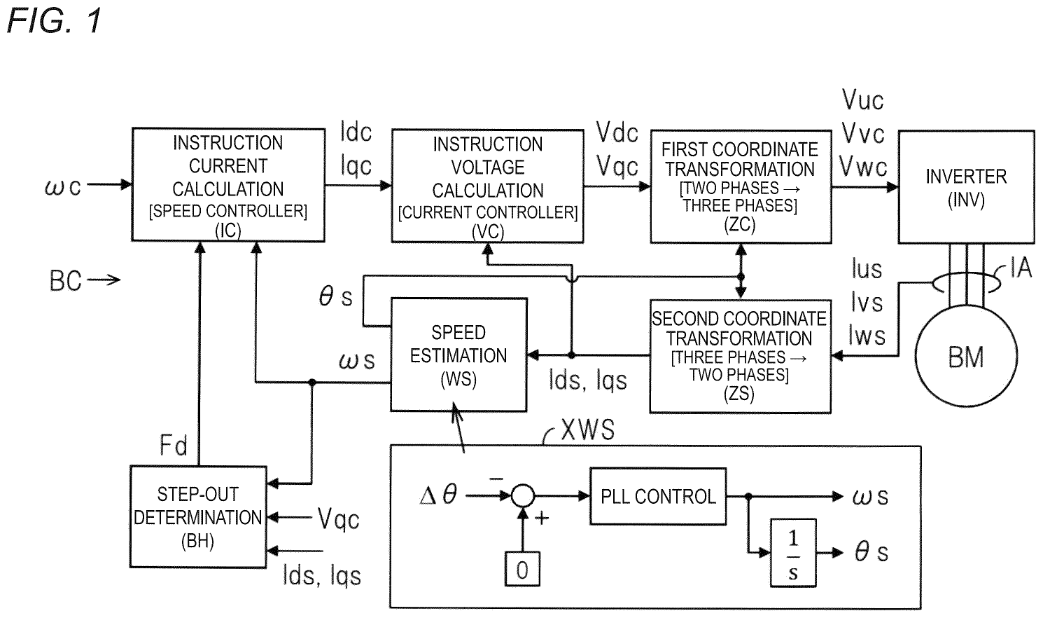

An embodiment of a motor control device MS will be described with reference to a block diagram of FIG. 1. A brushless motor BM is a synchronous motor provided with coils of three phases of a U phase, a V phase, and a W phase. The brushless motor BM is controlled (driven) by the motor control device MS. As the brushless motor BM, a sensorless type is adopted. Therefore, a position sensor (rotation angle sensor) that detects the position (i.e., the rotation angle) of the rotor of the brushless motor BM is not provided.

The motor control device MS that drives the brushless motor BM is configured by a control unit BC and a determination unit BH.

### <<Control Unit BC>>

Since the brushless motor BM is a sensorless type, sensorless control (also referred to as “sensorless vector control”) is executed in the control unit BC. The sensorless control is a known motor driving method (see e.g., JP 2008-011616 A, JP 2019-208329 A, and JP 2022-110307 A). Hereinafter, the control unit BC will be briefly described.

In the control unit BC, the brushless motor BM is driven by vector-controlling the current of the d-axis component and the current of the q-axis component orthogonal to the d-axis. “d-axis, q-axis” is a control axis in the rotational coordinates (also referred to as “d-q coordinates”) of vector control. The “d-axis” extends in the direction of the magnetic flux axis of the permanent magnet and the “q-axis” extends in the torque direction. Here, the d axis and the q axis are orthogonal to each other. In a brushless motor having a rotation angle sensor, an actual d-axis and an actual q-axis (“real d-axis, real q-axis” or “true d-axis, true q-axis”) are identified by a detection result (i.e., the rotation angle) of the rotation angle sensor.

Since the sensorless brushless motor BM does not include a rotation angle sensor, the d-axis and the q-axis are estimated, and vector control (i.e., sensorless vector control) is executed. In the sensorless control, the control axis estimated as the d-axis of the rotational coordinate is called “estimated d-axis (or, virtual d-axis)”. Furthermore, the control axis estimated as the q-axis of the rotational coordinate is called “estimated q-axis (or virtual q-axis)”. Similarly to the relationship between the real d-axis and the real q-axis, the estimated d-axis and the estimated q-axis are orthogonal to each other. Note that an error between the real d-axis and the real q-axis and the estimated d-axis and the estimated q-axis is expressed as an “axial error Δθ (angle error)”.

The current instruction values in the estimated d-axis and the estimated q-axis are called “estimated d-axis and estimated q-axis instruction currents Idc, Iqc”. The currents generated in the estimated d-axis and the estimated q-axis in correspondence with the estimated d-axis and estimated q-axis instruction currents Idc and Iqc are called “estimated d-axis and estimated q-axis output currents Ids, Iqs”. The estimated d-axis and estimated q-axis output currents Ids and Iqs are estimated on the basis of the three-phase detection currents Ius, Ivs, and Iws (U-phase, V-phase, W-phase detection current). The estimated d-axis and estimated q-axis output currents Ids and Iqs are also called “estimated d-axis and estimated q-axis estimated currents Ids, Iqs (or, estimated d-axis and estimated q-axis response currents Ids and Iqs)”.

The control unit BC includes an instruction current calculation block IC, an instruction voltage calculation block VC, a first coordinate transformation block ZC, a second coordinate transformation block ZS, and a speed estimation block WS.

In the instruction current calculation block IC, the estimated d-axis and estimated q-axis instruction currents Idc and Iqc are calculated on the basis of the instruction rotational speed c (target value of motor rotational speed) and the estimated rotational speed ωs (estimated value of motor rotational speed). Specifically, in the instruction current calculation block IC, the estimated rotational speed ωs calculated in the speed estimation block WS is subtracted from the instruction rotational speed wc. Then, the estimated d-axis instruction current Idc to which the estimated d-axis output current Ids should follow is determined on the basis of the calculation result “@c-ws” (referred to as “rotational speed error Δω”). Furthermore, in the instruction current calculation block IC, the estimated q-axis instruction current Iqc to which the estimated q-axis output current Iqs should follow is calculated on the basis of the estimated d-axis instruction current Idc and the like. That is, the instruction currents Idc and Iqc in the estimated d-axis and the estimated q-axis are calculated such that the rotational speed error Δω becomes “0” and the estimated rotational speed ωs matches the instruction rotational speed ωc. The instruction current calculation block IC is a process for matching the estimated rotational speed ωs with the instruction rotational speed ωc, and functions as a “speed controller (controller for controlling the rotational speed)”.

In the instruction voltage calculation block VC, the estimated d-axis and estimated q-axis instruction voltages Vdc and Vqc (target values) are calculated on the basis of the estimated d-axis and estimated q-axis instruction currents Idc and Iqc (target values) and the estimated d-axis and estimated q-axis output currents Ids and Iqs (output values). In the instruction voltage calculation block VC, the instruction voltages Vdc and Vqc in the estimated d-axis and the estimated q-axis are calculated such that the current errors “Iqc-Iqs” and “Idc-Ids” in the estimated d-axis and the estimated d-axis both become “0” and the estimated d-axis and estimated q-axis output currents Ids and Iqs match the estimated d-axis and estimated q-axis instruction currents Idc and Iqc. Since the instruction voltage calculation block VC is a processing block for matching the estimated d-axis and estimated q-axis output currents Ids and Iqs with the estimated d-axis and estimated q-axis instruction currents Idc and Iqc, the instruction voltage calculation block VC functions as a “current controller (controller for controlling the estimated current)”.

In the first coordinate transformation block ZC, the U-phase, V-phase, and W-phase instruction voltages Vuc, Vvc, and Vwc (target values) are calculated on the basis of the estimated d-axis and estimated q-axis instruction voltages Vdc and Vqc (target values). Specifically, the estimated d-axis and estimated q-axis instruction voltages Vdc and Vqc are coordinate transformed from two phases to three phases on the basis of the estimated rotation angle θs calculated by the speed estimation block WS, whereby the U-phase, V-phase, and W-phase instruction voltages Vuc, Vvc, and Vwc are determined. The U-phase, V-phase, and W-phase instruction voltages Vuc, Vvc, and Vwc are output to the inverter INV.

In the inverter INV, power is supplied to the brushless motor BM by the PWM control (pulse width modulation control) on the basis of the U-phase, V-phase, and W-phase instruction voltages Vuc, Vvc, and Vwc, and the brushless motor BM is driven. Specifically, pulse width modulated signals are determined according to the U-phase, V-phase, and W-phase instruction voltages Vuc, Vvc, and Vwc. Then, the switching element (MOS-FET, IGBT, etc.) is controlled according to the signal, and the U-phase, V-phase, and W-phase supply currents Ius, Iuv, Iws (also referred to as “detection currents”) to the brushless motor BM are adjusted. That is, the U-phase, V-phase, and W-phase supply currents Ius, Iuv, and Iws are controlled as a result of the U-phase, V-phase, and W-phase instruction voltages Vuc, Vvc, and Vwc.

A current sensor IA is provided to detect the motor currents Ius, Iuv, Iws supplied from the inverter INV to the brushless motor BM. Since the phase differences among the U-phase, V-phase, and W-phase supply currents Ius, Iuv, and Iws are known, the supply currents (e.g., the U-phase detection current Ius and the V-phase detection current Ivs) of two phases of the three phases may be detected by the current sensor IA, and the supply current (e.g., the W-phase detection current Iws) of the remaining one phase may be estimated. That is, the currents actually supplied to the three phases are detected by detecting the supply currents of at least two phases of the three phases by the current sensor IA.

In the second coordinate transformation block ZS, the estimated d-axis and estimated q-axis output currents Ids and Iqs are calculated on the basis of the U-phase, V-phase, and W-phase detection currents Ius, Iuv, and Iws. Specifically, the detection currents Ius, Iuv, and Iws are coordinate transformed from three phases to two phases on the basis of the estimated rotation angle θs calculated by the speed estimation block WS, whereby the estimated d-axis and estimated q-axis output currents Ids, Iqs are determined. Here, the estimated d-axis and estimated q-axis output currents Ids and Iqs (output values) correspond to the estimated d-axis and estimated q-axis instruction currents Idc and Iqc (input values, target values).

In the speed estimation block WS, the estimated rotational speed ωs and the estimated rotation angle θs are calculated on the basis of the estimated d-axis and estimated q-axis output currents Ids and Iqs. In the speed estimation block WS, first, the estimated rotational speed ωs is calculated. Then, the estimated rotational speed ωs is then integrated to determine the estimated rotation angle θs. For the calculation of the estimated rotational speed ωs, a known method such as a current drawing method, a harmonic wave superposition method, a magnetic flux observer method, or an expansion induced voltage method is adopted.

For example, in the speed estimation block WS, as indicated by the balloon section XWS, the control amount of the PLL control when the axial error Δθ is controlled to follow “0 (target value)” is determined as the estimated rotational speed ωs. Here, in the phase locked loop (PLL) control, feedback control is applied on the basis of an input periodic signal, and a phase-synchronized signal is output from another oscillator.

Since the target value of the axial error Δθ is set to “0”, the axial error Δθ is input to the PLL control block. In the PLL control block, the axial error Δθ is multiplied by a proportional gain Kp to calculate a proportional term. In addition, the axial error Δθ is time integrated and multiplied by an integration gain Ki to calculate an integral term. Then, the sum of the proportional term and the integral term is determined as the estimated rotational speed ωs (i.e., “ωs=Kp·Δθ+Ki·∫Δθ·dt”). Furthermore, the estimated rotational speed ωs is time integrated to determine an estimated rotation angle θs (i.e., “θs=∫ωs·dt”).

For example, in the speed estimation block WS, the calculation method of the axial error Δθ (angle error between the real q-axis and the estimated q-axis) is selectively used on the basis of the rotational speed. When the rotational speed is small (at time of low speed), the axial error Δθ is determined on the basis of the harmonic wave superposition method. In the harmonic wave superposition method (also referred to as “disturbance superposition method”), the high frequency voltage of the pulse (or a sinusoidal wave) is superimposed (applied) on the estimated d-axis instruction voltage Vdc. Then, the axial error Δθ is estimated on the basis of the amplitude change of the high frequency component of the estimated q-axis output voltage Iqs at this time.

On the other hand, when the rotational speed is high (at time of high speed), the axial error Δθ is calculated on the basis of the expansion induced voltage method. In the expansion induced voltage method, an axial error Δθ (angle error) is calculated by estimating an induced voltage from a voltage and a current. Specifically, the axial error Δθ is estimated on the basis of the estimated rotational speed ωs (previous value in the calculation cycle), the estimated d-axis and estimated q-axis output currents Ids and Iqs, and the estimated d-axis and estimated q-axis instruction voltages Vdc and Vqc.

The estimated rotational speed ωs calculated by the speed estimation block WS is input to the instruction current calculation block IC and the determination unit BH. Furthermore, the estimated rotation angle θs calculated by the speed estimation block WS is input to the first and second coordinate transformation blocks ZC and zS.

### <<Determination Unit BH>>

The determination unit BH determines the presence or absence of step-out in the brushless motor BM. In a brushless motor including a rotation angle sensor, a coil phase optimum for torque generation is always determined on the basis of information on the rotation angle, and thus step-out (asynchronization between a rotating magnetic field and a rotor having a permanent magnet) does not occur. However, in a brushless motor not including a rotation angle sensor, synchronization between a rotating magnetic field and a rotor is performed by estimation, and thus step-out may occur at the time of high load, sudden change in load, or the like.

In the determination unit BH, presence or absence of occurrence of step-out is determined on the basis of the estimated rotational speed ωs, the estimated q-axis instruction voltage Vqc, the estimated d-axis and estimated q-axis output currents Ids and Iqs. Then, when the occurrence of step-out is determined, the determination signal Fd is output toward the instruction current calculation block IC. For example, the determination signal Fd is transmitted as a control flag (also referred to as a “determination flag”). Specifically, in the determination flag Fd, “0” indicates that step-out has not occurred, and “1” indicates that step-out has occurred. Therefore, the time point (corresponding calculation cycle) at which the transition from “Fd=0” to “Fd=1” occurs is the step-out occurrence time point.

In the instruction current calculation block IC of the control unit BC, a process of recovering the step-out state is executed on the basis of the determination flag Fd. For example, from the time point when “Fd=1” is received, the instruction rotational speed ωc is decreased.

### <Details of Determination Unit BH>

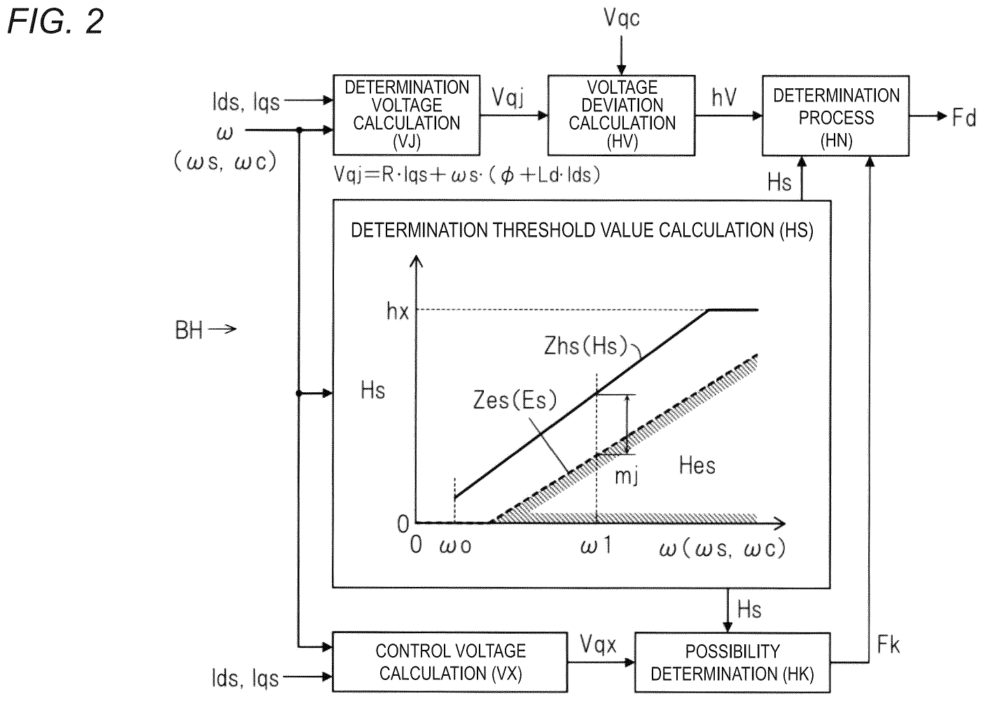

Details of the determination unit BH will be described with reference to the block diagram of FIG. 2. The estimated rotational speed ωs, the estimated q-axis instruction voltage Vqc, and the estimated d-axis and estimated q-axis output currents Ids and Iqs are input to the determination unit BH. In the determination unit BH, a deviation hV (voltage deviation) between the determination voltage Vqj calculated from the estimated rotational speed ωs and the estimated d-axis and estimated q-axis output currents Ids and Iqs, and the estimated q-axis instruction voltage Vqc is calculated. Then, the presence or absence of step-out of the brushless motor BM is determined by comparing the voltage deviation hV with the determination threshold value Hs.

The determination unit BH includes a determination voltage calculation block VJ, a voltage deviation calculation block HV, a determination threshold value calculation block HS, a limit voltage calculation block VX, a possibility determination block HK, and a determination processing block HN.

In the determination voltage calculation block VJ, the determination voltage Vqj is calculated on the basis of the estimated rotational speed ωs, and the estimated d-axis and estimated q-axis output currents Ids and Iqs. The “determination voltage Vqj” is a voltage to be applied to the estimated q-axis when it is assumed that the brushless motor BM is not out of step and is rotating at the estimated rotational speed ωs. Specifically, the determination voltage Vqj is determined on the basis of Equation (1).

$$Vqj = R \cdot Iqs + ω s \cdot ( φ + Ld \cdot Ids ) \qquad Equation ( 1 )$$

Here, “R” represents a resistance value (nominal value) of the brushless motor BM, “φ” represents an interlinkage magnetic flux (nominal value) of the brushless motor BM, and “Ld” represents a d-axis inductance (nominal value) of the brushless motor BM. Here, the “nominal value” is an average value of the actually measured data.

$$A first term Sv 1 ( = “ R \cdot Iqs ” ) in \qquad Equation ( 1 )$$

corresponds to a voltage drop in the brushless motor BM when the estimated q-axis output current Iqs is energized. In addition, the second term Sv2 (= “ωs·(φ+Ld·Ids)”) of Equation (1) corresponds to the counter electromotive voltage in the brushless motor BM when rotated at the estimated rotational speed ωs. Therefore, in the calculation of the determination voltage Vqj, the first term Sv1 (also referred to as “first component”) corresponding to the voltage drop in the brushless motor BM is calculated on the basis of the estimated q-axis output current Iqs. Furthermore, a second term Sv2 (also referred to as a “second component”) corresponding to the counter electromotive voltage in the brushless motor BM is calculated on the basis of the estimated rotational speed ωs and the estimated d-axis output current Ids. Then, the sum of first component Sv1 and second component Sv2 is determined as the determination voltage Vqj.

In the voltage deviation calculation block HV, a voltage deviation hV that is a difference between the determination voltage Vqj and the estimated q-axis instruction voltage Vqc is calculated on the basis of the determination voltage Vqj and the estimated q-axis instruction voltage Vqc. For example, the voltage deviation hV is determined on the basis of Equation (2).

$$hV = Vqj - Vqc \qquad Equation ( 2 )$$

As described above, the determination voltage Vqj is a voltage corresponding to the estimated q-axis instruction voltage Vqc in a state in which step-out has not occurred and the brushless motor BM is appropriately operated at the estimated rotational speed ωs. Therefore, the voltage deviation hV, which is the difference between the determination voltage Vqj and the estimated q-axis instruction voltage Vqc, is a state quantity (state variable) representing the extent (degree) of step-out. Therefore, the voltage deviation hV is calculated to be larger the larger the extent of step-out of the brushless motor BM (the difference between the instruction rotational speed ωc and the actual motor rotational speed).

For example, in a state in which the brushless motor BM is appropriately driven by sensorless control without being stepped out (i.e., state in which the estimated rotational speed ωs substantially matches the actual motor rotational speed), the estimated q-axis instruction voltage Vqc and the determination voltage Vqj are equal to each other. Therefore, in this state, the voltage deviation hV is “0”. On the other hand, in a state in which the brushless motor BM is stepped out and the rotation is completely stopped (i.e., state in which the estimated rotational speed ωs is generated, but the actual rotational speed is “0”), the estimated q-axis instruction voltage Vqc does not include second component Sv2 corresponding to the counter electromotive voltage. Thus, the voltage deviation hV matches the second component Sv2. Therefore, when the brushless motor BM is stepped out and the actual motor rotational speed is “0”, “hV=ωs·(φ+Ld·Ids)=Sv2” is calculated. That is, the maximum value of the voltage deviation hV is the second component Sv2, and the voltage deviation hV changes in a range from “0” to the second component Sv2.

In the determination threshold value calculation block HS, the determination threshold value Hs is calculated on the basis of the estimated rotational speed @s. The “determination threshold value Hs” is a threshold value for determining the presence or absence of step-out. A calculation map Zhs, which is a characteristic for calculating the determination threshold value Hs, is set in advance as a characteristic of the determination threshold value Hs with respect to the estimated rotational speed ωs. The characteristic Zhs is then stored in a microprocessor in the motor control device MS. The determination threshold value Hs is determined according to the calculation map Zhs set in advance so as to become larger the larger the estimated rotational speed ωs.

As described above, when the brushless motor BM is appropriately operated (i.e., when step-out has not occurred), the determination voltage Vqj is equal to the estimated q-axis instruction voltage Vqc, and thus the voltage deviation hV is determined to be “0”. However, in the motor control device MS, the detection results Ius, Ivs, Iws (current detection values) of the current sensor IA include variations (errors). Similarly, in the brushless motor BM as well, there are variations in the resistance value R, the interlinkage magnetic flux q, and the inductances Ld and Lq (induction coefficients) of the d-axis and the q-axis. Furthermore, the detection value (Ius etc.) of the current sensor IA and the characteristic (R, q, etc.) of the brushless motor BM fluctuates depending on the temperature or the like. Therefore, in a state in which the brushless motor BM is not out of step (i.e., the state of “hV=0”), the characteristic Zes of the error Es included in the sensorless control is calculated in advance. The error Es is referred to as a “steady state error”, and its characteristic Zes is referred to as a “steady state error characteristic”. The steady state error Es is an error included in the sensorless control in a steady state due to an error (variation and fluctuation) such as a detection value of the current sensor IA and a characteristic of the brushless motor BM.

The maximum value (worst value) of the steady state error Es is determined for each motor rotational speed using the motor rotational speed as a parameter in the combination of the variation and the temperature condition. Then, the maximum value of the steady state error Es is plotted with respect to the motor rotational speed, and the steady state error characteristic Zes is set. That is, the steady state error Es occurs in a range Hes (referred to as a “steady state error range”) surrounded by the horizontal axis (the axis of the estimated rotational speed ωs) and the steady state deviation characteristic Zes.

The calculation map Zhs for calculating the determination threshold value Hs is set to be always larger than the steady state error characteristic Zes. Specifically, a predetermined margin (margin value) is added to the steady state error characteristic Zes to set the calculation map Zhs. As a result, for example, when the estimated rotational speed ωs is the value @1, the determination threshold value Hs according to the calculation map Zhs is calculated to be larger than the steady state error Es corresponding to the steady state error characteristic Zes by the margin value mj. Since the determination threshold value Hs is not included in the range Hes (steady state error range) of the steady state error Es, step-out can be accurately determined.

In the steady state error characteristic Zes, the steady state error Es becomes larger the higher the motor rotational speed. In order to efficiently avoid the determination threshold value Hs from being included in the error range of the steady state error Es, the calculation map Zhs is set to be larger the larger the estimated rotational speed ωs. Furthermore, the calculation map Zhs is provided with an upper limit value hx. In addition, in the calculation map Zhs, a lower limit speed ω is provided so that the step-out determination is restricted when the estimated rotational speed ωs is low. That is, when the estimated rotational speed ωs is less than the lower limit speed ω, the determination related to step-out is not executed. Here, the “upper limit value hx” and the “lower limit speed ω” are predetermined values (constants) set in advance.

In the limit voltage calculation block VX, the limit voltage Vqx is calculated on the basis of the estimated rotational speed ωs, and the estimated d-axis and estimated q-axis output currents Ids and Iqs. The “limit voltage Vqx” is a value obtained by considering the worst value (maximum value) of the error Et (“detection error (or, the second error)”) with respect to the second component Sv2 (maximum value that the voltage deviation hV can take). Hereinafter, the calculation of the limit voltage Vqx will be described.

In the limit voltage calculation block VX, first, the voltage deviation hV in a state in which the brushless motor BM is stepped out and the actual motor rotational speed is “0” is calculated as “stop voltage Vqt” by the following equation (3). Here, stop voltage Vqt is equal to second component Sv2.

$$Vqt = ω s \cdot ( φ + Ld \cdot Ids ) = Sv 2 \qquad Equation ( 3 )$$

As described above, “φ” is the interlinkage magnetic flux (nominal value) of the brushless motor BM, and “Ld” is the d-axis inductance (nominal value) of the brushless motor BM.

Next, a detection error Et (second error) included in the stop voltage Vqt is calculated by the following equation (4).

$$Et = R \cdot Iqs \cdot ( Δ R + Δ I - Δ V ) - ω s \cdot Ld \cdot Ids \cdot Δ I \qquad Equation ( 4 )$$

Here, “ΔR” represents a variation error of a resistance value of the brushless motor BM, “ΔI” represents an error related to a current (also referred to as a “current monitoring error”), and “ΔV” represents an error related to a voltage (also referred to as a “voltage monitoring error”). In the sensorless control, the estimated d-axis and estimated q-axis output currents Ids, Iqs, the estimated d-axis instruction voltage Vdc and estimated q-axis instruction voltage Vqc, and the like are determined on the basis of the detection results Ius, Ivs, Iws (U-phase, V-phase, W-phase detection currents) of the current sensor IA. Therefore, the current monitoring error ΔI and the voltage monitoring error ΔV are caused by errors included in the detection currents Ius, Ivs, Iws by the current sensor IA.

Finally, the detection error Et is subtracted from the stop voltage Vqt to determine the limit voltage Vqx (see equation (5)). The limit voltage Vqx is a minimum value that can be taken by the stop voltage Vqt in consideration of the detection error Et.

$$Vqx = Vqt - Et \qquad Equation ( 5 )$$

In the possibility determination block HK, “whether or not execution of step-out determination is permitted” is determined on the basis of the determination threshold value Hs and the limit voltage Vqx. This determination is called “possibility determination”. Specifically, when the determination threshold value Hs is less than the limit voltage Vqx (i.e., in the case of “Hs<Vqx”), execution of the step-out determination is permitted. On the other hand, when the determination threshold value Hs is greater than or equal to the limit voltage Vqx (i.e., in the case of “Hs≥Vqx”), execution of the step-out determination is prohibited. The result of the possibility determination is output as a control flag Fk (also referred to as “possibility flag”). In the case of “Hs<Vqx” and execution is permitted, “Fk=0 (permit)” is determined. On the other hand, in the case of “Hs≥Vqx” and execution is not permitted, “Fk=1 (prohibit)” is determined.

In the determination processing block HN, the presence or absence of step-out is determined on the basis of the possibility flag Fk and the comparison between the voltage deviation hV and the determination threshold value Hs. This determination is called “step-out determination”. First, in the determination processing block HN, “whether or not execution of step-out determination is permitted” is determined on the basis of the possibility flag Fk. When the execution of the step-out determination is prohibited at “Fk=1”, the step-out determination is not performed. When the execution of the step-out determination is permitted at “Fk=0”, the step-out determination is performed.

The step-out determination is performed on the basis of “whether or not the voltage deviation hV has reached the determination threshold value Hs”. Specifically, when the voltage deviation hV is less than the determination threshold value Hs, the occurrence of step-out is denied. On the other hand, when the voltage deviation hV is greater than or equal to the determination threshold value Hs, the time Tx (referred to as “duration”) is counted during which the state (i.e., state in which the voltage deviation hV has reached the determination threshold value Hs) is continued from the time point (corresponding calculation cycle) when it is satisfied for the first time. Then, when the duration Tx of the state of “hV≥Hs” has reached the determination time tx, the occurrence of step-out is affirmed. Here, the “determination time tx” is a predetermined value (constant) set in advance. In the determination processing block HN, “Fd=0 (without step-out)” is output when the occurrence of step-out is denied, and “Fd=1 (with step-out)” is output when the occurrence of step-out is affirmed.

### <Setting of Determination Threshold Value Hs and Possibility Determination on Step-Out Determination>

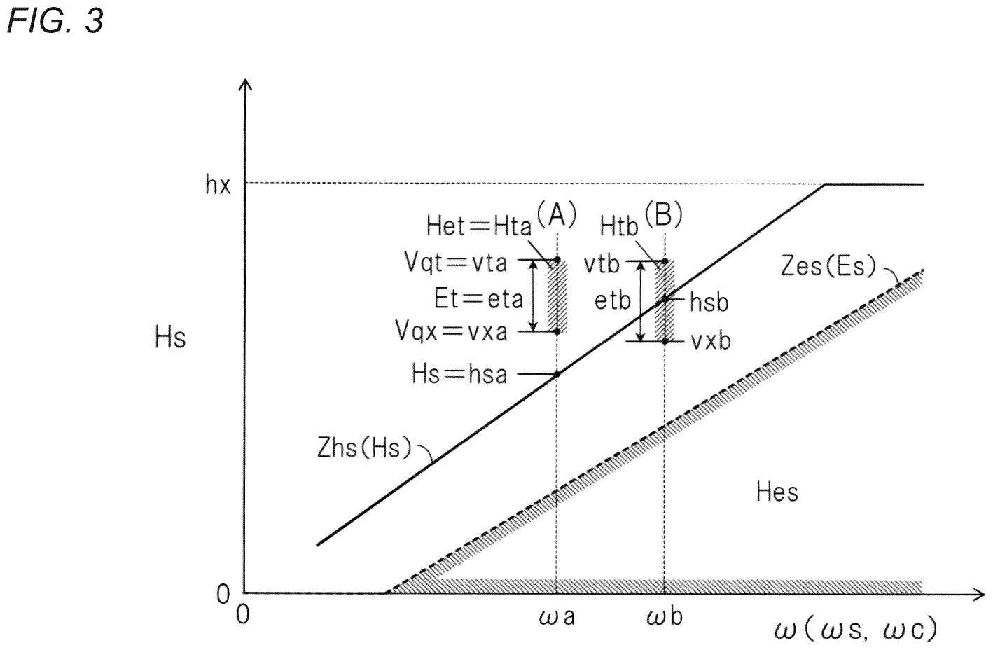

The setting of the determination threshold value Hs in consideration of the steady state error Es and the possibility determination related to the step-out determination in consideration of the detection error Et will be described with reference to the characteristic diagram of FIG. 3.

The determination threshold value Hs is a threshold value corresponding to the voltage deviation hV for identifying presence or absence of occurrence of step-out in the brushless motor BM. As described above, the determination threshold value Hs is calculated on the basis of the estimated rotational speed ωs and a preset calculation map Zhs. Specifically, the determination threshold value Hs is determined to be larger the larger (higher) the estimated rotational speed ωs according to the calculation map Zhs.

### <<Compensation of Steady State Error Es (First Error)>>

In the setting of the calculation map Zhs, the steady state error Es in the sensorless control is considered, and the influence thereof is compensated. The steady state error Es is an error included in the sensorless control in a steady state when the brushless motor BM is normally driven by the sensorless control (i.e., a state in which step-out has not occurred and the estimated rotational speed ωs is appropriately estimated). The steady state error Es is caused by variations, temperature, and the like, and is included in the detection value of the current sensor IA, the characteristics of the brushless motor BM, and the like. The maximum value (worst value) of the steady state error Es is plotted with respect to the estimated rotational speed ωs and set as the steady state error characteristic Zes. The steady state error Es occurs in a range less than or equal to a value along the characteristic line of the steady state error characteristic Zes. A range that can be taken by the steady state error Es is the steady state error range Hes. Note that the steady state error characteristic Zes can be obtained in advance by experiment, analysis, calculation, or the like.

The calculation map Zhs is set in advance as a characteristic larger than the steady state error characteristic Zes such that the calculation map Zhs is not included in the steady state error range Hes. As a result, since the determination threshold value Hs is determined to be a value larger than the steady state error Es, the influence of the steady state error Es on the determination threshold value Hs is eliminated.

### <<Compensation of Detection Error Et (Second Error)>>

Furthermore, in the calculation of the determination threshold value Hs, the detection error Et in the sensorless control is taken into consideration, and the influence thereof is compensated. The detection error Et is an error included in the stop voltage Vqt (the second component Sv2) representing the limit of the voltage deviation hV when step-out occurs in the brushless motor BM. The cause of the detection error Et is an error of the U-phase, V-phase, or W-phase detection currents Ius, Ivs, or Iws detected by the current sensor IA or the like. When the maximum values (the worst values) of the detection errors Et are simply accumulated, an overlapping portion occurs between the error range Het (referred to as “detection error range”) of the detection error Et and the error range Hes of the steady state error Es. In the overlapping range between the detection error range Het and the steady state error range Hes, the determination threshold value Hs is included in these error ranges, and it is difficult to eliminate the error. That is, in the simple addition of the worst condition of the detection error Et, the executable range of the step-out determination is extremely narrowed. Therefore, for the detection error Et, “whether or not determination threshold value Hs is included in detection error range Het” is determined every time the determination threshold value Hs is calculated in the sensorless control. That is, whether or not step-out determination is possible is determined for each calculation cycle according to the calculated determination threshold value Hs.

For example, at the time point (corresponding calculation cycle) indicated by the state (A), the stop voltage Vqt is calculated to the value vta. At the same time, the detection error Et is calculated to be the value eta. Then, the limit voltage Vqx is determined to be the value vxa (=vta−eta). In addition, the determination threshold value Hs is calculated to be the value hsa according to the calculation map Zhs. At this time, the value hsa (=Hs) is smaller than the value vxa (=Vqx). Since the determination threshold value Hs is outside the range Hta (indicated by hatching) which is the detection error range Het in the state (A), the step-out determination is permitted. When the voltage deviation hV is greater than or equal to the determination threshold value Hs at the time of the state (A), the occurrence of step-out is affirmed. On the other hand, when the voltage deviation hV is less than the determination threshold value Hs, the occurrence of step-out is denied.

On the other hand, at the time point (corresponding calculation cycle) indicated by the state (B), the stop voltage Vqt is calculated to be the value vtb, and the detection error Et is calculated to be the value etb. Then, the limit voltage Vqx is determined to be the value vxb (=vtb−etb). In addition, the determination threshold value Hs is calculated to the value hsb. At this time, the value hsb (=Hs) is greater than or equal to the value vxb (=Vqx). Since the determination threshold value Hs is included in the range Htb (indicated by hatching) which is the detection error range Het in the state (B), the step-out determination is prohibited. Therefore, in the state (B), the occurrence of step-out is denied.

In the step-out determination, “Fd=0 (no step-out has occurred)” is set as an initial value. Then, when both “the determination threshold value Hs is less than the limit voltage Vqx” and “the voltage deviation hV is greater than or equal to the determination threshold value Hs” are satisfied (specifically, in a case where the time Tx at which both of the two conditions are satisfied is continued over the determination time tx), occurrence of step-out is identified, and “Fd=1 (step-out has occurred)” is determined. On the other hand, in the case of “Hs≥ Vqx” (i.e., when step-out determination is prohibited) or in the case of “hV<Hs” (i.e., when step-out has not occurred), the state of “Fd=0” is maintained.

The influence of the detection error Et is not compensated by being set in advance, but compensated by determining whether or not step-out determination is possible (i.e., whether or not the determination threshold value Hs is included in the detection error range Het) for each calculation cycle in which the determination threshold value Hs is calculated. As a result, the range in which step-out determination can be performed is sufficiently secured in consideration of the influence of various errors Es and Et.

The error compensation in the step-out determination is summarized above. The various state quantities used for the step-out determination include various errors such as variations in characteristics (resistance value R, inductances Ld and Lq, interlinkage magnetic flux q, etc.) of the brushless motor BM, a characteristic change of the brushless motor BM dependent on temperature, and a detection error of the current sensor IA. In the motor control device MS, the determination threshold value Hs is determined so as not to be included in the range Hes of the first error Es which is a steady state error in the sensorless control by the calculation map Zhs set in advance. Furthermore, in the motor control device MS, when the determination threshold value Hs is calculated, the calculated determination threshold value Hs is compared with the limit voltage Vqx in consideration of the second error Et including the detection error of the current sensor IA and the like. Then, on the basis of the comparison result, whether or not step-out determination using the determination threshold value Hs is possible is determined. That is, in the motor control device MS, the step-out determination with high reliability is executed in consideration of both the first error Es and the second error Et.

### <Modified Example of Motor Control Device MS>

In the embodiment of the motor control device MS described above, the estimated rotational speed ωs is used for the calculation of the voltage deviation hV, the determination threshold value Hs, the limit voltage Vqx, and the like. As a modified example of the motor control device MS, in these calculations, the instruction rotational speed ωc can be adopted instead of the estimated rotational speed ωs. Specifically, in at least one of equations (1), (3), and (4), the instruction rotational speed ωc is used instead of the estimated rotational speed ωs. The modified example also has the same effect as those described above. That is, since the calculation map Zhs is set so that the steady state error Es (first error) is not included in the determination threshold value Hs, the influence of the steady state error Es is eliminated in the step-out determination. In addition, the detection error Et (second error) is reflected on the stop voltage Vqt to determine the limit voltage Vqx, and the possibility of step-out determination is determined on the basis of the magnitude relationship between the determination threshold value Hs and the limit voltage Vqx. As a result, in the step-out determination, the executable region is secured while taking into consideration the detection error Et.

In the motor control device MS, the instruction rotational speed ωc or the estimated rotational speed ωs is adopted as the state quantity related to the rotational speed of the brushless motor BM. The instruction rotational speed ωc and the estimated rotational speed ωs are collectively called “rotational speed ω”. Therefore, the determination voltage Vqj, the stop voltage Vqt, the second error Et, and the limit voltage Vqx are calculated on the basis of the rotational speed ω. In addition, in the calculation map Zhs, the determination threshold value Hs is determined to be larger the higher (larger) the rotational speed ω.

### Summary of Embodiments

Hereinafter, embodiments of the motor control device MS will be summarized.

The motor control device MS includes a control unit BC that performs sensorless control of the brushless motor BM having three phases, and a determination unit BH that determines the presence or absence of step-out of the brushless motor BM. In the determination unit BH, a deviation hV (voltage deviation) between the determination voltage Vqj calculated from the rotational speed ω of the brushless motor BM and the estimated q-axis instruction voltage Vqc of the sensorless control is calculated. Then, the presence or absence of step-out is determined by comparing the voltage deviation hV with the determination threshold value Hs. Here, the rotational speed ω is either the instruction rotational speed c or the estimated rotational speed ωs.

In the determination unit BH, the calculation map Zhs for calculating the determination threshold value Hs is set to be larger than the characteristic Zes of the first error Es (steady state error) included in the sensorless control in the state in which the brushless motor BM is not out of step (non-step out state). Since the voltage deviation hV is “O” at the time of non-step-out, the first error Es is an error when the magnitude (absolute value) of the voltage deviation hV is a minimum (=0). Since the calculation map Zhs is set to be larger than the steady state error characteristic Zes, the determination threshold value Hs is always determined to be outside the range Hes of the first error Es. That is, in the step-out determination, the first error Es is taken into consideration, and the determination threshold value Hs is appropriately determined such that the influence thereof is compensated.

In the steady state error characteristic Zes, the first error Es increases as the motor rotational speed increases. In addition, second component Sv2 representing the degree of step-out changes according to the rotational speed ω (generic term for instruction value ωc and estimated value ωs). Therefore, the calculation map Zhs for calculating the determination threshold value Hs is set as a characteristic of the determination threshold value Hs with respect to the rotational speed ω. In addition, in the calculation map Zhs, the determination threshold value Hs is determined to be larger the higher (larger) the rotational speed ω. As a result, the determination threshold value Hs can efficiently avoid the range Hes of the first error Es, and the step-out determination can be appropriately executed.

In the determination unit BH, the determination voltage Vqj determined in the stop state of the brushless motor BM is calculated as the stop voltage Vqt on the basis of the estimated d-axis output current Ids and the rotational speed ω in the sensorless control. Furthermore, a detection error Et (second error) included in the stop voltage Vqt is calculated on the basis of the estimated d-axis and estimated q-axis output currents Ids and Iqs, and the rotational speed ω in the sensorless control. When the determination threshold value Hs is greater than or equal to a value (i.e., the limit voltage Vqx) obtained by subtracting the detection error Et from the stop voltage Vqt, the step-out determination is prohibited.

The limit voltage Vqx calculated in each calculation cycle is the worst value (i.e., the minimum value that can be taken by the stop voltage Vqt) in which the second error Et (detection error) is considered with respect to the determination voltage Vqj (=Sv2) in the state where step-out has occurred and the brushless motor BM is stopped. In a case where the determination threshold value Hs is greater than or equal to the limit voltage Vqx, the determination threshold value Hs is included in the range Het of the second error Et. Therefore, execution of the step-out determination is prohibited.

In consideration of the worst condition of the first and second errors Es and Et, a region outside the range Hes of the first error Es and outside the range Het of the second error Et is limited. For this reason, if the worst conditions of the second error Et are simply accumulated, the region from which the error influence can be eliminated becomes narrow. In the determination unit BH, the second error Et is taken into consideration for each calculation cycle of the determination threshold value Hs. Specifically, each time the determination threshold value Hs is calculated, it is compared with the limit voltage Vqx. According to the comparison, whether or not the determination threshold value Hs is included in the range Het of the second error Et is determined. Thus, the second error Et is considered after the region where the step-out determination can be executed is sufficiently secured. As a result, in the motor control device MS, the first and second errors Es and Et are appropriately compensated, and highly accurate step-out determination can be executed.

1. A motor control device comprising:
a control unit that performs sensorless control of a brushless motor having three phases; and
a determination unit that determines presence or absence of step-out of the brushless motor by comparing a deviation between a determination voltage calculated from a rotational speed of the brushless motor and an estimated q-axis instruction voltage of the sensorless control with a determination threshold value; wherein
the determination unit sets a calculation map for calculating the determination threshold value to be larger than a characteristic of a first error included in the sensorless control in a state in which the brushless motor is not out of step.

2. The motor control device according to claim 1, wherein
the determination unit sets the calculation map such that the determination threshold value is determined to be larger the higher the rotational speed.

3. The motor control device according to claim 2, wherein
the determination unit,
calculates, as a stop voltage, the voltage deviation determined in a stop state of the brushless motor on the basis of the estimated d-axis output current and the rotational speed,
calculates a second error included in the stop voltage on the basis of the estimated d-axis and estimated q-axis output currents, and the rotational speed, and
prohibits the determination when the determination threshold value is greater than or equal to a value obtained by subtracting the second error from the stop voltage.

4. The motor control device according to claim 1, wherein
the determination unit,
calculates, as a stop voltage, the voltage deviation determined in a stop state of the brushless motor on the basis of the estimated d-axis output current and the rotational speed,
calculates a second error included in the stop voltage on the basis of the estimated d-axis and estimated q-axis output currents, and the rotational speed, and
prohibits the determination when the determination threshold value is greater than or equal to a value obtained by subtracting the second error from the stop voltage.
